(19) United States
(12) Patent Application Publication
(10) Pub. No.: US 2011/0029459 A1
(43) Pub. Date: Feb. 3, 2011

(54) PERSONALIZED INTERACTIVE MAIL PUBLISHING METHOD

(76) Inventors: Jean-Noël Schneider, Marseilles (FR); Gilles Barré, Paris (FR)

Correspondence Address: HARNESS, DICKEY & PIERCE, P.L.C., P.O. BOX 828, BLOOMFIELD HILLS, MI, 48303, US

(21) Appl. No.: 12/443,259

(22) PCT Filed: Sep. 28, 2007
(86) PCT No.: PCT/FR07/01590

§ 371 Date: Jan. 5, 2010

(30) Foreign Application Priority Data
Sep. 29, 2006 (FR) 0608566

(51) Int. Cl. G06F 17/00; G06Q 40/00

(52) U.S. Cl. 705/408; 705/39

(57) ABSTRACT

The disclosure relates to a personalised interactive mail publishing method which can be used to consult personal data, trigger actions or acknowledge receipt in an instant and secure manner. The method includes: formation or extraction of the constituent data of a printable code; generation of complementary variables, such as for authentication; concatenation and compaction of the data from the code to be printed; formation of a file containing the data from the code to be printed and from the mail; conversion of the codes to enable optoelectronic capture; encapsulation of the code in a data flow; printing prior to the distribution of the mail or package; capture of the printed code by the recipient using, for example, a mobile telephone fitted with a camera; interpretation of the symbols forming the code using an embedded module; processing of the instructions contained in the code; connection to the server; encryption and comparison with the encryption performed by the embedded module; authentication; and access to the information indexed in the databases made available by the originator of the mail.

### CROSS-REFERENCE TO RELATED APPLICATIONS

This application is a National Phase Entry of International Application No. PCT/FR2007/001590, filed on Sep. 28, 2009, which claims priority to French Application 06 08566, filed on Sep. 29, 2006, both of which are incorporated by reference herein.

### BACKGROUND AND SUMMARY

The present invention relates to a method used for the traceability, geographic positioning and interactivity of paper mail, and enabling, from a personal mail and a mobile terminal linked to a person, the instant and secure access to network accessible individual information, as well as the secure transmission of orders, acknowledgements of receipt and/or certificates of distribution.

Although electronic mail has become extremely current, the traditional mail is still widely used more particularly by large scale emitters. Paper mail has a few advantages with respect to the electronic mail: it can be read anywhere, it is more practical for some control and pointing processing operations, it takes advantage of formalism and a status of official document, it is inevitable for many large scale emitters for regulatory and/or commercial reasons. Electronic mail, however, has enormous advantages:
The capacity of better controlling the distribution and reception of mail, using automatic alarms in case of non distribution and thanks to the possibility of instant sending back of acknowledgements of receipt.
The capacity of having hypertext links making it possible for the recipient to have instant access to network accessible additional individual information. This characteristic gives rise to the “push/pull” model adopted by many large scale emitters of electronic mails, wherein information transported by electronic email is “pushed” via a downlink channel when it is sent to the recipient interrogates the emitter's server by clicking on a link.

The following advantages result from the latter characteristic:
The capacity of giving a spontaneous access, after authentication, to private information associated to a personal account.
The capacity of giving a spontaneous access to files including sound and moving pictures, to better show and highlight products or services.
The possibility of an instant answer from the recipient, thus avoiding writing on a paper, placing it into an envelope and posting at the post office of a coupon or any answering means.

As regards information on the distribution and reception of the paper mail, a recent solution consists in placing a radio frequency identification label in the mail, so that a detection and saving device positioned close to the receiving letter boxes, can detect the presence of the mails. But such a system requires an infrastructure and authorisations to equip the letter boxes, which are difficult to obtain in the buildings.

The access a network accessible content can be done according to a known method by optoelectronic capture of a printed link corresponding to the data of the required file, for example an internet address (URL), shown as a code, more particularly a mono- or bi-dimensional bar code, or written using a font such as DOTEM (French patent No. 0501552, dated 16 Feb. 2005, published on 18 Sep. 2006 with publishing No. 2882173, filing date PCT Jul. 2, 2006 under No WO206/087446). The method is made possible thanks to the technologies implemented within electronic terminals, whether portable or not, more particularly associating the functions of telecommunication, data optoelectronic acquisition, emitter's identification and display of information. It makes it possible to facilitate the access to information while thus avoiding a tedious or complicated input on a keyboard, and/or to prohibit the access to the users not having purchased the requested rights.

The access to content available on a computer network becomes possible, from any mass printed media such as packaging, newspapers, magazines, posters, folders, fliers. Each printed copy gives equally access to the computer content, from the moment that the recipient's terminal has a printed code recognition device or even clearance to the service, using an encryption key of the read character chain. But this technique is not specifically applied to personalised and individualised industrial mails, wherein each copy is different. The reader of a magazine, for example, will have access to the service with an authorised terminal, from an enciphered and printed code on a copy equally obtained by subscription, in a waiting room or at a friends' domicile.

On the contrary, the person having a personal mail and also having an authorised terminal will have to be able to have an instant access to his or her own private information from the code printed in his/her mail, but the access shall necessarily be forbidden to him/her, if the mail is not intended for him or her. In addition, it is advisable that the printed codes can be de-activated on expired mails while remaining active on the newest mails. In addition, they must be generated on the fly in the manufacturing chain of such mails, and from personalised information relative to each recipient and mentioned in the emitter's computer file.

Consequently, according to the invention, each mail shall contain one or several individual links generated according to a personalisation and computer composition technique and assuring that the correct link is published on the correct document and enabling individual and exclusive authorisations taking into account the electronic terminal used, the mail read and a predetermined period of activation. Such links completed by the information stored in the emitter's terminal, such as his or her personal phone number, shall make it possible to have access to a private information, to place an order like to receive an additional document to one's personal address, or authorise a payment from a mono- or bi-dimensional bar code, or an instruction written with a font such as DOTEM, published for example on an invoice or a statement of account. The method will thus be an additional and instant security in the authorisation and authentication process, since it will make the validity of this authorisation or authentication depend on the reading of a unique mono- or bi-dimensional bar code (or an instruction written in DOTEM font) which is found in a personal and confidential mail, combined with the user's identification through the information linked to him or her through his or her terminal such as his or her phone number. As regards the payment authorisation, the debtors now have various payment possibilities to pay for their invoices to their creditors. This is the reason why they more particularly can pay with a check or a credit card or an interbank order to pay, bank transfers or even other procedures and finally the automatic debit through the authorisation of debit granted to the creditor.

This means of payment is particularly appreciated by creditors, current providers, phone or other operators. The advantage is that they can be automatised, thus they enable reduced receipt charges with respect to other receipt means, and more particularly to take the lead, since the debit order they transmit to the bank only depending on them. Because of this last point, many debtors refuse to use this payment method insofar as they are no longer capable of making an ex ante control on the debits on their accounts.

Then, creditors duly identified with an emitter number send debit orders from their debtors' accounts, who are clients in various banks, without an additional approval being requested from them. Theoretically, both the creditor and the bank must have received the authorisation to debit from their client. Practically, the banks do not manage the authorisations to pay from their clients with computers. So much so that an emitter can transmit a debit order which has no reason, which the bank will pay at least at first. This is because of the insecurity of such a procedure, where the creditor totally depends on third parties' honesty and on the correct operation of the system that numerous persons do not want to give any authorisation to debit, even though they would not have to use more complex procedures.

The interactivity method from a mail described in this patent makes it possible to create a new payment means: the Conditional Authorisation to Debit. The creditor shall always have to obtain an authorisation to debit from his or her client, but using such authorisation to debit will depend on the prior agreement from the debtor before every operation.

Another aim of the invention consists in supplying the emitter reliable and accurate information on the execution of the mail distribution phase. The upstream phases of the mail distribution have systems making it possible to follow up, unitarily or in batches, the posted mails, but the information remains insufficient on the execution of the “last mile” during the distribution itself. Using a personalised link visible in the carrier envelope, the method according to the invention will make it possible to supply individual distribution information before the reception by the recipient, without requiring the application of specific labels nor the equipment of distribution places with detection and saving equipment. The method issues a certificate of distribution, and guarantees that the capture of the visible connection in the window of the envelope is made on the distribution place, in the recipient's letter box. This information intended for the emitter is transmitted from geographical positioning terminals used by the mailers and is a complement to the acknowledgement of receipt which can be obtained by the capture of a personalised link upon the taking of the lead or the opening of a mail or a package by the recipient.

The present invention relates to a personalised publishing method making it possible to provide the paper mail with interactivity capacities which are useful for the individualised relation with the recipient of said mail and for the control of the distribution, more particularly for the instant and secure access to network available individual information, as well as the secure transmission of orders, acknowledgement of receipts and/or a certificate of geographically positioned distribution. The method according to the invention aims at upgrading the paper mail with respect to the electronic mail by providing it with the above-mentioned capacities without requiring the systematic utilisation of a keyboard. The mail shall then be called “Hypermail”.

These new capacities require a specific combination of means, more particularly as regards the emitter's publishing application system enabling the personalised publishing of mails, as regards the systems embedded on the recipients' or mailers' mobile terminals, as well as during the authentication system implemented by the emitter. For this purpose, the invention provides a personalised interactive mail publishing method including the following steps:
generation of publishing variable used by the emitter so as to produce computer published specific data in the form of printed codes, in the body and the address area of the mail;
the recognition of printed codes making it possible to process information and instructions contained in said printed codes and being the subject of a specific module submitted by the emitter, and embedded more particularly by downloading on the recipient's and/or the mailer's personal telecommunication terminal;
the authentication makes it possible for each recipient to have access to the information relating to him or her and only such information, to place orders such as requests for documents, acceptance or refusal of proposals, authorisation to debit within a payment process, from a chain of characters specific to each mail, completing other means such as those of a password or the recipient's strong identification terminal.

According to a first characteristic of the method, the phase of generation of publishing variable includes the following steps:
constitution of a database or extraction, from existing data base, of indexing data to be inserted into each printed code and associated instruction, more particularly a codification of the server or servers, making it possible to answer the recipient's request, one or several personal identifiers making it possible to find the individual information such as a contract number, an account number, a file number, a registration number, the social security number or a zip code;
optional addition of one or several fields including a codification of a message to be displayed on the recipient's terminal off connection or prior to a connection, more particularly rates information, submitted to the recipient's approval such as the price of the service and the cost of the connection. In case of a paying service, these information can be displayed on the recipient's terminal screen, and submit the connection to a keyboard input confirming or not confirming the recipient's approval. If the connection is paid for by the emitter, (which is equivalent to a prepaid answering envelope, such information can be confirmed by a simple display on the recipient's terminal screen;
generation of a random number belonging to each mail and to be inserted in each printed code and transmitted to an authentication server. The number, which can include a counter incremented on each publishing, enables the authentication and management of accesses per recipient and per mail according to a protocol which shall be described subsequently in the part devoted to authentication;
concatenation and formatting of said publishing variables composed by a succession of fields delimited by tags. Each tag corresponds to a processing instruction and each field contains the information to be processed;
optional compaction of said variables consisting in expressing some values according to a binary encoding and in saving this encoding in a table which enables a large number of values per character when associated with the utilisation of a printed code, for example of the DOTEM type (Pat. No. 0,501,552 dated 16 Feb. 2006, published on 18 Aug. 2006 publication No 2882173, filing date PCT Jul. 2, 2006 under No WO206/087446);
insertion of said publishing variables into the sequential file containing the application data of each male using specific characters having the function of an index or a tag;
on the fly conversion of said publishing variables into printable and operable codes by optoelectronic capture such as the bi-dimensional codes Datamatrix, QR code or DOTEM. This operation is carried out upon the composition of the document composing the mail, using a converter incorporated in a composition software or using a specific character font;
encapsulation of publishing resources in a dataflow limiting the handling and modification of the printable data, more particularly bi-dimensional codes through the utilisation of a document printing format like AFP (Advanced Function Presentation), in ACIF (Advanced Conversion and Indexation Facility), Postscript or PDF modes; said codes are positioned and published on the document composing the mail by setting a composition or post composition software in a visible area in the envelope window for the functions of traceability, confirmation of distribution and/or acknowledgement of receipt and/or in a non visible area in the envelope window for the functions of instant access to a private content.

Under these conditions, a mail is the support of a downlink channel towards the recipient and/or towards a mailer, and the codes associated with this mail and with it only enable the spontaneous utilisation of one or several linking channels towards the emitter by any wireless communication means. According to a non illustrated alternative solution, the production of these publishing variables includes a specific step of triggering using a regulation software so as to trigger the publishing of printable codes, more particularly bi-dimensional codes as a function of criteria, such as the recipient's name and address, his or her personal situation as regards his or her profile, product ownership, behaviour, history of requests for example upon the capture of the codes published on the previous items.

According to another particular embodiment, the production of such publishing variables includes the following additional steps:
conversion of the address of the mail recipient into terrestrial coordinates. This geographical positioning data can be expressed using a geographic information system for example in latitude/longitude, with the essential being that it can be compared to terrestrial coordinates determined by a satellite system or a terrestrial mobile network upon the capture of the printed code;
addition, intended for the printed code appearing in the window of the envelope, of fields including geographical positioning data and information relating to the history of the postal processing, such as codified data relating to a postal contract, stamping, theoretical date of the posting, to the putting in an envelope, to the client, to the person who posted it, to the various depot nodes and to the emitter;
optional addition of tags and specific fields, included in the printed code visible in the window or in a specific code printed in the body of the mail, or on a list or on a label sent together with a parcel, integrating a reference or instruction instantly enabling the sending of an acknowledgement of receipt simultaneously sent to the emitter and to the concerned parties and/or the processing of specific requests from the recipient such as for example the replacement of goods or an additional order.

According to one of the characteristic of the invention, the processing includes a printed code recognition module, more particularly bi-dimensional codes supplied by the emitter and embedded for example by downloading into the recipient's or the mailer's telecommunication personal terminals. Said terminal must enable the optoelectronic acquisition of data, such as a mobile telephone provided with a camera. Upon the acquisition or the downloading of this module, the identifier and the password of the recipient is recorded and transmitted to an authentication server.

Said recognition module follows the steps mentioned herein under:
capture and decoding of symbols forming the printed code;
the interpretation of tags limiting several fields of the printed code, each tag corresponding to a processing instruction and each field containing information to be processed;
processing of information contained in the terminal memory and in the field of the printed code by making it possible to link or to combine the various processing instructions according to a predefined program. As a non limitative example, the processing instructions can be: display read information, store information in a memory area, connect to a server the coordinates of which are for example stored in a memory area of the recipient's terminal, dial a telephone number also stored in the memory of said terminal, encipher using a secret key a chain of characters, send a piece of information to a server to supply a database or trigger an action such as the sending of an individual document or alarms, in paper or electronic form, confirmation of a reception, triggering of a payment, capture of a code, for example on a paper invoice or any other media such as an electronic mail displayed on a screen or printed, composing a condition of authorisation in the bank debit process, triggering of an additional delivery or the replacement of a faulty parcel for example;
connection and transmission to the server made available by the emitter, of the chain of characters including more particularly the data, making it possible to find the requested content and to authentify the recipient. The authentication password entered or stored in the recipient's terminal, includes an algorithm making it possible to encipher a sequence composed of the password stored in the memory and a random number belonging to each mail and obtained by the capture of a specific field of the printed code.

Under these conditions, the direct authentication of the recipient and the spontaneous access to private information can be executed without requiring the systematic input of the password on the keyboard, nor the presence thereof, in the code printed on the mail, nor the transmission thereof not coded, on the network. The optoelectronic capture of the code belonging to each mail can also be completed by the input of the password and the utilisation of data relative to the recipient such as his or her personal phone number, stored in a memory of his or her terminal. Under these conditions, the validity of the authentication is both conditioned to the possession of said mail sent to one person and by the possession of the terminal connected to the same person. Similarly, the optoelectronic capture of said code may condition the triggering of actions submitted to the recipient's authorisation such as a payment or a bank debit. As regards the conditional authorisation to debit, the creditor shall always have to obtain the authorisation to debit from its client, but the utilisation of this authorisation to debit will be conditioned to the debtor's previous approval before each operation. The creditors generally send an invoice to their clients prior to the debiting of the payment on their clients' accounts. They will only have to add said code on the invoices to have their debtor clients click on this code to indicate that they agree on the debiting of the amount of the invoice by the creditor directly from their bank accounts, and the debtor will send a message acknowledging receipt of the approval to his or her debtor, for example through an SMS or through an email.

According to a non illustrated alternative solution, the capture of the code by the debtor generates at the same time as or as a replacement of the sending of the agreement to the creditor, an agreement directly transmitted to the debtor's bank. Then, the bank would have the approval of the authorisation to debit remitted by the creditor. The bank would then debit the account only upon reception of its client's approval transmitted via the capture of the code mentioned on an invoice. According to a non illustrated alternative solution, the connection to the server is direct for the capture of complete coordinates inscribed in the printed code, thus entailing a second connection towards a server, the address of which is pre-saved in the module embedded in the recipient's terminal, so as to supply a base containing the history of all the direct connections.

According to a particular embodiment, said recognition module can be embedded in a specific terminal used by the mailer provided with a geographic positioning module, a satellite system such as Galileo and GPS (Trademarks) or terrestrial mobile network, making it possible to supply terrestrial coordinates of the terminal used. In this case, said recognition module makes it possible to interpret a specific printed code, which is visible in the window of the envelope carrying said mail, and to prove the distribution thereof by the mailer at the moment of the capture of said printed code by carrying out the following steps:
comparison of terrestrial coordinates, for example expressed in latitude/longitude by the geographic positioning module and coordinates expressed in the same units in a field of said printed code;
certification of the distribution as a function of the above-mentioned comparison: if the discrepancy is lower than a tolerance threshold, predefined as a function of the accuracy of the geographical positioning module, the distribution is validated, if not so it is invalidated;
optional saving of information on the time of distribution using an internal clock, optionally that in the mobile terminal;
saving of information relating to the certificates of distribution per mail and the information on the history on the post processing contained in the printed code such as encoded data relating to the postal contract, the stamp, the theoretical date of the posting, the letter of the client, the person who posted it, the various depot nodes, the emitter;
teletransmission of this information on a continuous flow basis, or on keeping such information for a grouped transmission at the end of the session, for example at the end of the round, for saving follow-up bases which can be accessed by the emitter or various users of the service.

According to another characteristic of the invention, the method includes an authentication phase according to the following steps:
data identifying the recipient of the mail such as his or her personal number, his or her identifier and his or her password are recorded upon the acquisition by the recipient of the recognition module to be downloaded for example onto his or her mobile terminal;
a random number incorporating a counter incremented, for example upon each publishing is inserted into the printed code on each mail using a variable generator belonging to the process;
said variable generator transmits to the authentication server and upon each publishing, the random number and the counter indexed per recipient;
upon completion of the capture, the module embedded in the recipient's terminal and belonging to the method, enciphers the random number, the counter and the recipient's identification data using an algorithm shared with the authentication server;
the authentication server carries out the same enciphering operation using the saved identifier and/or password and compares the result obtained with the one transmitted by the recipient's terminal. If both results are equal, the authentication is a success, if not so it fails.

This method is a system of authentication by response challenge using a physical mail used as an up-linking channel combined with personal information stored in the recipient's terminal, like his or her phone number, it enables the direct and instant authentication of the recipient without requiring the systematic input of the password on a keyboard, nor the presence in the code published in the mail, nor the transmission encoded on the network. It conditions the authentication to the retention of the mail and the associated code, as well as the possession of the terminal linked to the recipient. The counter existing in the chain of characters to be enciphered makes it possible, by incrementation, to manage the accesses as a function of the recent characteristic of the mail. This preferred authentication method does not exclude an encryption or additional hatching of data used by the method.

### BRIEF DESCRIPTION OF DRAWINGS

The appended drawings illustrate the method:

FIG. 1 illustrates the interactivity with the recipient of the mail; and

FIG. 2 illustrates the traceability of the distribution of the mail or of the package.

### DETAILED DESCRIPTION

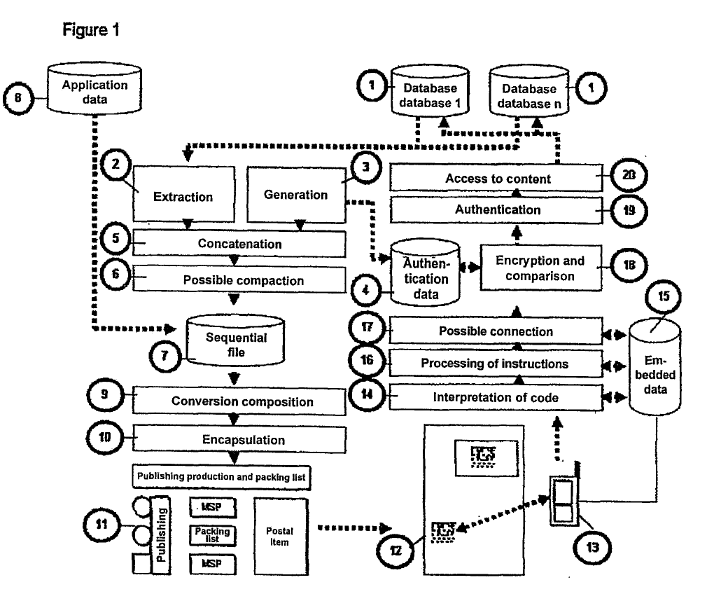

As illustrated in FIG. 1, the method includes: the constitution of a database 1 or the extraction 2 of data and tags composing the code to be printed, more particularly the personal identifiers making it possible to find the recipient's private information; the generation of the complementary variables 3 such as a random number used for the authentication, recorded in an authentication database 4; the concatenation of such data and tags into a chain of characters composed of a succession of fields delimited by tags 5; the optional compaction of the information contained in the code to be printed, through the encoding of such information 6; the composition of a sequence file 7 including the chain of characters composing the code to be printed and the mail application data 8; the composition and conversion of the chain of characters into codes which can be operated by an optoelectronic capture 9; encapsulation of the code to be printed into a flow of data in the form of a printing file 10; the electronic printing, the placing in an envelope or in a parcel and the distribution of the mail or the package 11; the capture by the recipient of the printed code 12 using for example a mobile telephone provided with a camera 13; the interpretation of symbols and tags forming the printed code 14 using data stored in a module embedded on the recipient's terminal such as his or her phone number 15; the processing of instructions and information contained in the printed code and in the memory of the embedded module, more particularly the enciphering of a sequence composed of the password recorded in the terminal and the random number read on the printed code 16; the connection to the server encoded in a field of the printed code and the address of which can be stored in the module embedded in the recipient's terminal 17; the enciphering, more particularly of a password saved upon the subscription to the service and the random number saved in the authentication data upon the generation of the complementary variables and the comparison with the enciphering carried out by the module embedded in the recipient's terminal 18; the authentication conditioned by the compliance of both results 19; the access, thanks to personal identifiers included in the printed code to private information 20, indexed in the databases 1 made available by the emitter.

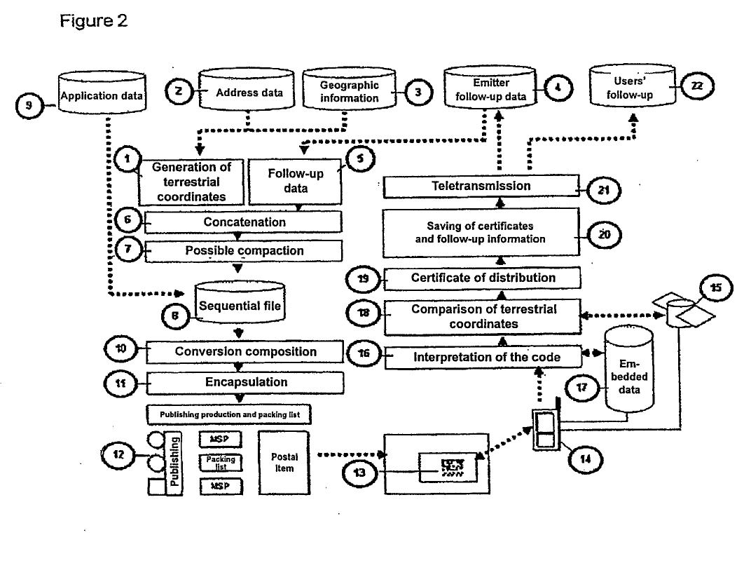

As illustrated in FIG. 2, the method includes: the generation of terrestrial coordinates 1 through the conversion of the address of the mail recipient 2 using a geographic information system 3; the collection of data from a processing follow-up basis 4, more particularly references encoded in the postal contract, the stamp, the envelope, the client, the person who posted it, the posting nodes, the emitter, the theoretical date of the posting 5; the concatenation of such data and tags into a chain of characters composed of a succession of fields defined by tags 6; the optional compaction of information contained in the printable code through the encoding of such information 7; the constitution of a sequential file 8 including the chain of characters composing the printable code and the mail application data 9; the composition and conversion of the chain of characters into codes which can be operated by an optoelectronic capture 10; the encapsulation of the printable code into a flow of data 11; the electronic printing, the putting in an envelope or in a package and the distribution of the mail of the package 12; the capture by the mailer of the printed code visible in the envelope window 13 using, for example, a mobile telephone provided with a camera 14 and a geographical positioning module, more particularly using a satellite system 15; the interpretation of symbols and tags composing the printed code 16 using data stored in a module embedded in the mailer's terminal 17; the comparison of terrestrial coordinates 18 given by the satellite system 15 and coordinates expressed according in the same units in a field of the printed code 13; the certification or non certification of the distribution as a function of the above-mentioned comparison 19; the saving of certificates and follow-up information 20 collected in the printed code 13; the teletransmission of the savings and follow-up information 21 by session or on a continuous flow basis, for enrichment of the emitter's 4 follow-up database and the various users of the service 22.

1. A method for the traceability and interactivity of paper mail, enabling the instant access to individual information on line or the secure transmission of orders, through the combined use of a personal mail and a mobile terminal linked to a person, the method comprising the following phases:
a) generation of variables in the form of printable bi-dimensional codes in the body of the mail including the following steps: generation of a random number and a counter for the authentication, concatenation and formatting of said variables including a personal identifier, conversion on the fly of such variables into bi-dimensional codes and encapsulation in the printing file of mails to be published; and
b) recognition of said codes by optoelectronic capture from a personal telecommunication terminal used by the recipient of the mail including the following steps: capture and decoding of the fields and tags forming the code, processing of the information and instructions contained in the code and in the program of the terminal used, connection and transmission of the data composed of an enciphered sequence grouping specific authentication data captured on the mail completed by data linked to the recipient and stored in a memory of his or her terminal, authentication of the mail recipient and instant access to the services conditioned by the holding of the personal mail, as well as the possession of a mobile terminal linked to the recipient of said mail.

2. A method according to claim 1, further comprising certifying the distribution of the mail wherein the phase a) includes the additional steps of converting the address of the mail recipient into terrestrial coordinates, concatenation of such coordinates with the references of the letter, the mail emitter and the theoretical date of the mail posting, conversion on the fly of such variables into a bi-dimensional code intended to be visible outside the envelope, and in phase b) includes additional steps of: capture of the printed code by the mailer, comparison of the terrestrial coordinates inscribed in the bi-dimensional code printed on the mail with those determined by a geographical positioning module, by a satellite or a triangulation, embedded in the mailer's terminal, certification or not of the distribution as a function of the comparison results, retention of the results obtained for a grouped transmission at the end of the round.

3. A method according to claim 2, further comprising saving of information on the time of distribution through use of an internal clock.

4. A method according to claim 2, further comprising teletransmission, on a continuous flow basis, of the results of the certification of distribution by mail.

5. A method according to claim 1, wherein the capture of the code on an invoice on paper or any other media such as electronic mail, and the authentication of the mail recipient is an approval for a bank debit transmitted to a creditor.

6. A method according to claim 5, wherein the bank debit authorisation is transmitted directly to the debtor's bank, and in that the debtor's bank will debit the account only when receiving its client's approval transmitted via the capture of the code mentioned on an invoice or any other paper or electronic media.

7. A method according to claim 1, wherein phase a) includes an additional step of adding one or several fields including the encoding of a message to be displayed on the recipient's terminal off connection or prior to a connection, more particularly rates information, submitted to the recipient's approval.

8. A method according to claim 1, wherein phase a) includes the adding of a specific field or printed code intended to instantly acknowledge receipt, to the emitter and to the concerned parties, of the mail or of a package or, using a reference mentioned in said code, to place an additional order or to instantly request the replacement of the delivered goods.

9. A method according to claim 1, wherein phase a) includes an additional step of compaction of said publishing variable consisting in expressing some values according to a binary codification, authorising a large number of values per character.

10. A method according to claim 1, wherein phase a) includes an additional triggering step using a rule software, in order to trigger the publishing of printable codes as a function of criteria linked to the personal data associated with the mail recipients, and to the history of the requests made by capture on the preceding items.
